(19) United States
(12) Patent Application Publication
(10) Pub. No.: US 2010/0127102 A1
(43) Pub. Date: May 27, 2010

(54) NOZZLE FOR APPLICATION OF FLOWABLE BUILDING MATERIAL

(76) Inventor: Oliver Vic Barry, Suffolk (GB)

Correspondence Address: ABELMAN, FRAYNE & SCHWAB, 666 THIRD AVENUE, 10TH FLOOR, NEW YORK, NY, 10017, US

(21) Appl. No.: 12/310,344

(22) PCT Filed: Aug. 14, 2007
(86) PCT No.: PCT/GB2007/003097

§ 371 Date: Jan. 20, 2010

(30) Foreign Application Priority Data
Aug. 19, 2006 (GB) 0616520.3

(51) Int. Cl. B05B 1/00

(52) U.S. Cl. 239/602; 222/566

(57) ABSTRACT

A nozzle for applying flowable building materials is provided. The nozzle (14) is formed with cleats (24, 24′) to allow its height to be adjusted.

### FIELD OF THE INVENTION

This invention relates to a nozzle for applying flowable building materials, such as mortar and also plaster whilst in a flowable condition, to brickwork or other surfaces. The invention is of particular use to pointing and repointing brickwork.

### BACKGROUND OF THE INVENTION

The application of flowable building materials, such as mortar and plaster for pointing and repair and the like, is conventionally by means of a trowel. UK Patent No. 2328240 describes an alternative means for applying such materials in the form of an hollow elongate body, with a flared opening at one end for introducing flowable material into the body and an outlet nozzle at the other end. An associated plunger is depressed to urge flowable material out of the body through the nozzle, for example to force out mortar when pointing brickwork. This reduces the time needed to apply mortar.

The nozzle described in GB 2328240 is rigid and different tasks may require different size nozzles so as to produce mortar of the correct depth. This means that a number of differently dimensioned nozzles need to be purchased and kept available for use dependent upon, for example, the depth of joint between bricks.

It is an aim of the present invention to provide a nozzle that is more versatile.

### SUMMARY OF THE INVENTION

In accordance with on aspect of the present invention there is provided a nozzle for apparatus for extruding fluid building material, the nozzle having a mating end for securing to apparatus and an outlet end, wherein the outlet end is formed with one or more cleats so as to be readily deformable to alter the cross-sectional area of the outlet end, without compromising the structural integrity of the nozzle. This allows the nozzle to be adjusted to correspond to a required height or width and so adjusted for different size mortar joints.

The cleat is readily collapsible on manual application of force using pliers and the like, and compresses to adjust the length of the wall of the nozzle in which it is formed.

Preferably the outlet end is formed with a pair of cleats, one each on opposing walls. These compress to reduce either width, or more usually the height of the nozzle, the height being the dimension that corresponds to height of the mortar joint. The length of walls without cleats is not altered when the cleats are compressed.

The cleats can be expanded if required by use of pliers and the like to increase wall length, but only by a small amount.

Preferably the nozzle is made of metal such as stainless steel or copper, desirably of a thickness in the range 0.2-0.8 mm, such as 0.3 mm, 0.4 mm or 0.5 mm.

In accordance with another aspect of the present invention, there is provided apparatus for extruding fluid building material comprising a hollow elongate body with a flared entrance and a nozzle, piston means removably located therein and slidable relative thereto to force fluid material ahead of the piston through the nozzle, wherein an outlet end of the nozzle is formed with one or more cleats so as to be readily deformable to alter the cross-sectional area of the outlet end, without compromising the structural integrity of the nozzle.

The invention will now be described by way of example with reference to the accompanying drawings, in which:

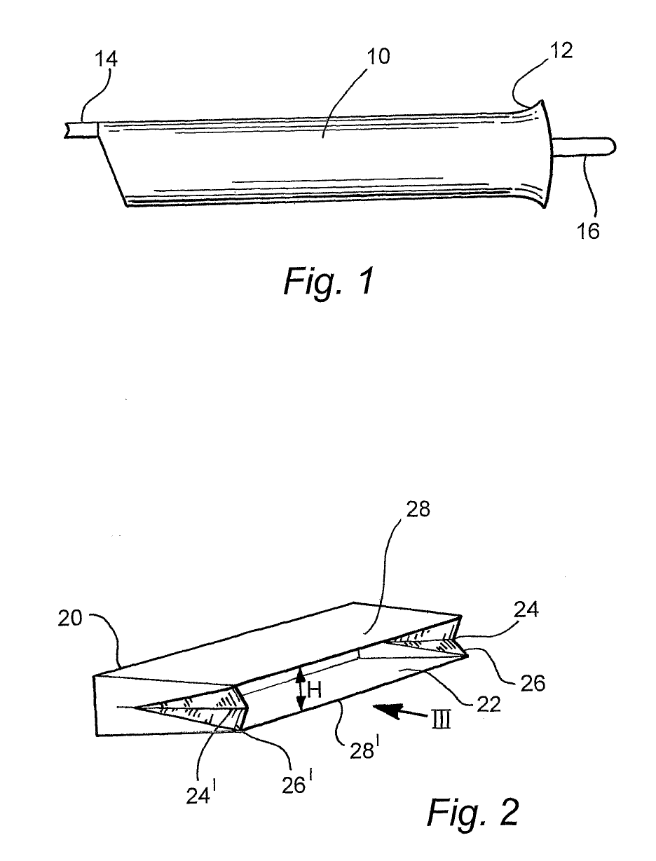

FIG. 1 is a side elevation of an apparatus with a nozzle in accordance with the invention;

FIG. 2 is a perspective view of the nozzle;

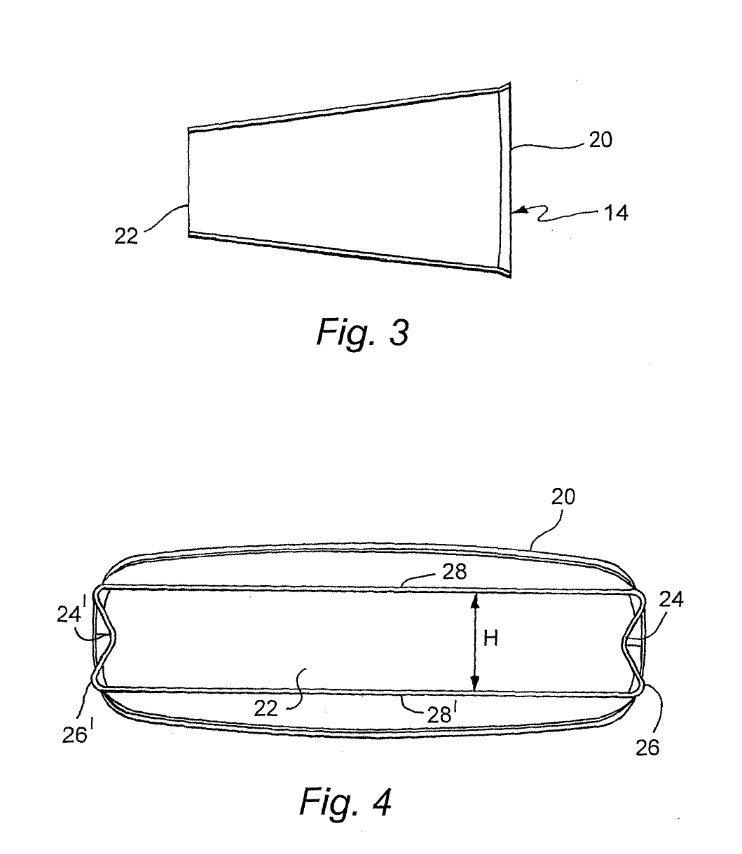

FIG. 3 is a cross section along line III of FIG. 2; and

FIG. 4 is a view from the front along line III of FIG. 2.

Referring to FIG. 1, an apparatus in accordance with the invention comprises a hollow elongate body 10 with a flared entrance 12 and a nozzle 14, and a separable plunger 16 shown in its fully depressed position, i.e. when no building material is contained within body 10. The body 10 has a cylindrical cross section, although a hollow body of any cross-sectional shape could be used. The body 10 is typically made from plastics materials such as polyvinyl chloride or polypropylene and has a thickness of at least 2 mm to ensure sufficient strength for containing a fluid building material such as mortar, without being too heavy. The nozzle 14 is typically made of metal, for example stainless steel, so as to provide better resistance to abrasion during use.

FIGS. 2, 3, 4 and 5 show the nozzle 14 in detail. The nozzle 14 is substantially rectangular in cross-section with a maximum height of approximately 20 mm and a width approximately 65 mm and comprises a mating portion 20 with a corresponding cross section to body 10 so as to engage and seal with body 10, and an outlet portion 22. The nozzle 14 tapers in cross-section from the mating portion 20 down to the outlet portion 22 as can be seen in FIG. 3 to give a height H of approximately 15 mm. Cleats 24, 24′ are formed in opposing walls 26, 26′ and are readily compressible by the manual application of pliers or the like to reduce the height H of the outlet portion 22, for example to 11 mm and 8 mm. Typically pliers will be opened to enclose wall 26 or 26′ by gripping walls 28 and 28′ and then closed partially to compress first cleat 24 and then cleat 24′ to give the required height H. The length of the other two walls is unaffected. This allows the height of the nozzle 14 to be modified to a range of heights. Thus the nozzle height can be matched to a mortar joint size.

Cleats can be formed in all four walls if required.

The nozzle 14 can be permanently fixed to body 10, or more usually is detachable to allow nozzle replacement when abrasion has distorted the nozzle and rendered it less efficient.

In use, a fluid building material, such as mortar or plaster, is placed into flared entrance 12 and allowed to flow into the cavity provided by body 10. The plunger 16 is used to lightly press the mortar to ensure that the body is completely filled with mortar and that no air gaps exist. The apparatus is then taken to the area where the building material is to be applied. The cleats are adjusted manually using pliers to ensure the nozzle height is correct for the gaps where the flowable material is to be applied, for example with pointing the height will be adjusted to match the gaps between the brick courses.

The nozzle outlet 22 is then placed between the gaps, or cavities, and the plunger 16 is depressed with sufficient force to slide in the body 10 and urge the mortar to flow out into the cavity. By use of the nozzle 14, the mortar is supplied to the back of the cavity first and then flows towards the front of the cavity. Thus each cavity is filled from the back of the wall towards the front. The apparatus is moved laterally and vertically until mortar fills all the gaps in the brickwork and is visible at the front surface of the wall. The mortar on the front surface of the wall is then pointed using a trowel. In this way, mortar and other building materials can be rapidly applied to a building

1. A nozzle for apparatus for extruding fluid building material, the nozzle having a mating end for securing to apparatus and an outlet end, wherein the outlet end is formed with one or more cleats so as to be readily deformable to alter the cross-sectional area of the outlet end.

2. A nozzle according to claim 1, wherein the outlet end is deformed to adjust its height.

3. A nozzle according to claim 1, wherein the outlet end is formed with a pair of cleats, one each on opposing walls.

4. A nozzle according to claim 1 made of metal.

5. Apparatus for extruding fluid building material comprising a hollow elongate body with a flared entrance and a nozzle, piston means removably located therein and slidable relative thereto to force fluid material ahead of the piston through the nozzle, wherein an outlet end of the nozzle is formed with one or more cleats so as to be readily deformable to alter the cross-sectional area of the outlet end, without compromising the structural integrity of the nozzle.

6. (canceled)

7. A nozzle according to claim 2, wherein the outlet end is formed with a pair of cleats, one each on opposing walls.

8. A nozzle according to claim 2 made of metal.

9. A nozzle according to claim 3 made of metal.
